(19) United States
(12) Patent Application Publication
(10) Pub. No.: US 2026/0147918 A1
(43) Pub. Date: May 28, 2026

(54) File Management Arrangement, Software Component Arrangement, Computer-readable Medium, a Circuitry Arrangement and a Method for File Management

(71) Applicant: Telefonaktiebolaget LM Ericsson (publ), Stockholm (SE)

(72) Inventors: Håkan Englund, Lund (SE); Fredrik Dahlgren, Lund (SE); Andreas Kristensson, Södra Sandby (SE); Alexander Hunt, Limhamm (SE); Michael Björn, Malmö (SE)

(21) Appl. No.: 19/130,600

(22) PCT Filed: Dec. 2, 2022
(86) PCT No.: PCT/EP2022/084257

§ 371 Date: May 16, 2025

(51) Int. Cl. G06F 21/62

(52) U.S. Cl. CPC G06F 21/6245; G06F 2221/2113

(57) ABSTRACT

A file management arrangement (100) comprising and a controller (101), wherein the controller (101) is configured to: receive a request for a file (210), the file (210) comprising one or more original objects (220-1, 220-2, 220-3), wherein the file (210) is associated with a first application (105); and provide a first variant (211B) of the file (210) corresponding to a first access level (215B), if the access level (215) for the request does not correspond to an original access level (215A), where the original access level is associated with the original file (210). The first variant (211B) of the file (210) includes a first number of one or more replacement objects (220-A, 220-B, 220-C) replacing the first number of the one or more original objects (220-1, 220-2, 220-3)

### TECHNICAL FIELD

The present invention relates to a file management arrangement, a computer-readable medium, a method, a computer software module arrangement, and a circuitry arrangement for providing different variants of a file based on an access level.

### BACKGROUND

Issues relating to privacy and personal integrity are becoming increasingly more important in today's society where data such as audio recordings and images are captured almost everywhere and at any given time. These issues are important to both persons creating such data and those willingly partaking in such data as well as to people accidentally captured. For example, a person taking a photo may not want a specific person or a random person making rude or offensive gestures or expressions to be captured in the photograph. This would ruin the photograph and also potentially inflict emotional harm to the person taking the photo or being at the center of the photo. Similarly, there may be persons that are accidentally or unintentionally captured in the photograph against their will.

Therefore, there exist many systems where files, such as images, are anonymized—automatically or through user input. However, such anonymized files are either stored as replacements of the original file or as permanent replacements, wherein the original file is not possible—or at least difficult—to retrieve.

There is thus a need for improved techniques for managing anonymized files.

### SUMMARY

Even if prior art provides different techniques for anonymizing images, for example by identifying objects in images and deleting or blurring such objects, there is a problem in prior art, as the inventors have realized, in that such anonymization make it difficult if not impossible to retrieve the original files. Furthermore, there is a further problem, as the inventors have realized, in that a user may not want all files, for example images, to be viewed in the same way by everyone. In the prior art, this has been solved by either blocking access completely to the file or by manually generating several copies and then storing these copies in different folders, whereby the folders have blocked or different access levels.

Thus, according to one aspect of the teachings herein a file management arrangement is provided comprising a controller, wherein the controller is configured to: receive a request for a file, the file comprising one or more original objects, wherein the file is associated with a first application; provide a first variant of the file corresponding to a first access level if the first access level does not correspond to an original access level, where the original access level is associated with the original file, wherein the first variant of the file includes a first number of one or more replacement objects replacing the first number of the one or more original objects.

In one embodiment, if the access level for the request corresponds to a second access level the controller is configured to provide a second variant of the file corresponding to a second access level, and wherein the second variant of the file includes a second number of replacement objects replacing the second number of the one or more original objects, wherein the first number is different to the second number, and/or wherein the second number of replacement objects are different from the first number of replacement objects.

In one embodiment the first access level is a higher access level than the second access level and the first number is lower than the second number and wherein the second number of replacement objects includes the first number of replacement objects.

In one embodiment the controller is further configured to provide a third variant of the file if the access level for the request corresponds to the original access level, wherein the third variant includes a third number of replacement objects, wherein the third number is lower than or equal to the first number and/or the third number of replacement objects is different to the first number of replacement objects.

In one embodiment, the controller is further configured to provide the original file if the access level for the request corresponds to the original access level. The original file in this case includes a first number of original objects and zero number of replacement objects.

In one embodiment the request is a third-party application request and wherein the access level is a third-party application access level, wherein the third-party application is not the first application.

In one embodiment the request is a user request received from a user through a user interface associated with the first application and wherein the access level is an access level for the user.

In one embodiment request is a composite request comprising a first request received from a user through a user interface, the first request being a user interface operated user request, and a second request received being a third-party application request.

In one embodiment the controller is further configured to determine that the request for the file is for a variant stored in a memory wherein the controller in response to the request is configured to provide the variant of the file stored in the memory, and if the variant is not stored in the memory. generate the variant of the file in response to receiving the request and provide the generated variant.

In one embodiment the controller is further configured to store any variant as an indication of which original object is to be replaced, whereby the original object to be replaced is replaced with the replacement object upon retrieving the variant.

In one embodiment the controller is further configured to store any variant as a copy of the file with the replacement object(s) replacing the original object(s) to be replaced.

In one embodiment the controller is further configured to determine that the request for the file is for a file to be generated, and in response thereto generate the variant corresponding to the access level for the file.

In one embodiment controller is further configured to receive sensor data from a sensor and to generate the variant corresponding to the access level based on the received sensor data.

In one embodiment the controller is further configured to generate the file as a capture of the sensor data and receive the sensor data through a file generating application, and wherein the file generating application comprises a first set of functionalities associated with the original access level and a second set of functionalities associated with the first access level.

In one embodiment the sensor is an image sensor arranged to provide image data.

In one embodiment one of the replacement objects is a blurred version of the corresponding original object.

In one embodiment one of the replacement objects is a deleted corresponding original object.

In one embodiment the controller is further configured to detect the original object to be replaced based on a context of the original object.

In one embodiment the context includes an identity of the original object and wherein the controller is further configured to replace the identity with the replacement object

In one embodiment the context includes a part of a human body and wherein the controller is further configured to replace the part of the human body with the replacement object.

In one embodiment the context includes a geographical location where the file is to be generated and wherein the controller is further configured to determine that the geographical location for file generation is a geographical location indicated as sensitive, and to detect objects to be replaced as objects comprising an identity.

In one embodiment the context further includes time of file generation, and wherein the controller is further configured to determine that the time of file generation is a time indicated as sensitive for the location of file generation.

In one embodiment the controller is further configured to detect at least one other object, determine a context of the at least one other object, compare the context of the original object to be replaced to the context of the at least one other object and to detect the original object to be in response to the context of the original object being different from the context of the at least one other object.

In one embodiment the context includes a pose, and wherein the original object is to be replaced in response to the original object being different from a pose of the at least one other objects object.

In one embodiment the context includes a facial expression, and wherein the original object is to be replaced in response to a facial expression of the original object being different from a facial expression of the at least one other objects object.

In one embodiment the context includes a distance to the at least one other object, and wherein the original object is to be replaced in response to the distance to the at least one other object exceeding a threshold distance.

In one embodiment the context includes a social identity, and wherein the original object is to be replaced in response to a social identity of the original object not being associated with a social identity of the at least one other object.

According to one aspect of the teachings herein there is provided a method for use in a file management arrangement, wherein the method comprises: receiving a request for a file, the file comprising one or more original objects, wherein the file is associated with a first application; providing a first variant of the file corresponding to a first access level if the access level does not correspond to an original access level, the original access level being associated with the original file, wherein the first variant of the file includes a first number of one or more replacement objects replacing the first number of the one or more original objects.

According to one aspect of the teachings herein there is provided a software component arrangement for use in a file management arrangement, wherein the software component arrangement comprises: circuitry for providing a first variant of the file corresponding to a first access level if an access level does not correspond to an original access level, the original access level being associated with the original file; wherein the first variant of the file includes a first number of one or more replacement objects replacing the first number of the one or more original objects.

According to one aspect of the teachings herein there is provided a file management arrangement comprising circuitry for receiving a request for a file, the file comprising one or more original objects, wherein the file is associated with a first application; circuitry for providing a first variant of the file corresponding to a first access level if an access level does not correspond to an original access level, the original access level being associated with the original file, wherein the first variant of the file includes a first number of one or more replacement objects replacing the first number of the one or more original objects.

According to one aspect of the teachings herein there is provided a computer-readable medium carrying computer instructions that when loaded into and executed by a controller of a file arrangement enables the capturing arrangement to implement the method according to the teachings herein.

The proposed solution thus enables for automatically provide different users access to different variants of the same file depending on the users'access levels.

The solution allows a substantially enhanced handling of privacy in media files such as photos and video, which might be imperative in future public and provide usage of devices with cameras (AR glasses, drones, etc.). The differentiated handling of privacy when granting access to applications, allowing the user to select privacy level (thereby taking an explicit responsibility of 3rd party privacy and not only consent regarding own privacy, with limitations disallowing the user to enable sharing of certain potentially privacy-infringing data).

### BRIEF DESCRIPTION OF THE DRAWINGS

FIG. 1A shows a schematic view of a file management arrangement according to some embodiments of the teachings herein;

FIG. 1B shows a schematic view of a file management arrangement according to some embodiments of the teachings herein;

FIG. 2 shows a schematic view of components and modules of a file management arrangement according to some embodiments of the teachings herein;

FIGS. 3A to 3K each shows a schematic view of a file management arrangement where objects are detected or replaced according to some embodiments of the teachings herein;

FIG. 4 shows a schematic view of how a file is provided from one device to a file management system and how a variant of the file is provided according to some embodiments of the teachings herein;

FIG. 5 shows a flowchart of a general method according to some embodiments of the teachings herein;

FIG. 6 shows a schematic view of a computer-readable medium carrying computer instructions that when loaded into and executed by a controller of an arrangement enable the arrangement to implement some embodiments of the teachings herein;

FIG. 7 shows a component view for a software component arrangement according to some embodiments of the teachings herein; and

FIG. 8 shows a component view for an arrangement comprising circuits according to some embodiments of the teachings herein.

### DETAILED DESCRIPTION

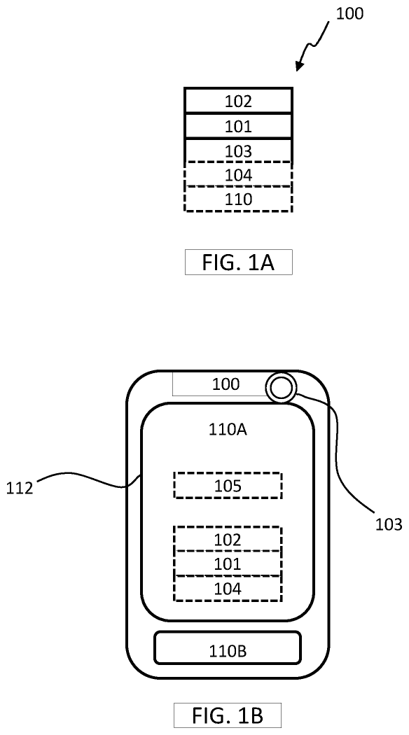

FIG. 1A shows a schematic view of a file management arrangement 100 according to some embodiments of the teachings herein. It should be noted that the file management arrangement 100 may comprise a single device or may be distributed across several devices and apparatuses.

The file management arrangement 100 comprises or is operably connected to a controller 101 and a memory 102. The controller 101 is configured to control the overall operation of the file management arrangement 100. The controller 101 comprises a combination of circuits that enable the controller 101 to control the operation of the file management arrangement 100. As a skilled person would understand, there are many ways in which a a controller 101 may be implemented, such as using Field-Programmable Gate Array (FPGA) circuits, Application Specific Integrated Circuits (ASICs), processors, etc. in addition or as an alternative. For the purpose of this application, all such possibilities and alternatives will be referred to simply as the controller 101.

The memory 102 is configured to store data, such as sensor data and computer-readable instructions that when loaded into the controller 101 indicate how the file management arrangement 100 is to be controlled. The memory 102 may comprise several memory units or devices, but they will be perceived as being part of the same overall memory 102. As a skilled person would understand, there are many possibilities of how to select where data should be stored and a general memory 102 for the file management arrangement 100 is therefore seen to comprise any and all such memory units for the purpose of this application. As a skilled person would understand, there are many alternatives of how to implement a memory, for example using non-volatile memory circuits, such as EEPROM memory circuits or using volatile memory circuits, such as RAM memory circuits. The memory 102 may also be external to the file management arrangement 100, such as an external physical memory in the form of an external storage unit (NVM, SSD, or disk-based) or in the form of a cloud storage solution. For the purpose of this application all such alternatives will be referred to simply as the memory 102.

In some embodiments the file management arrangement 100 also comprises one or more sensors 103. In one embodiment, the at least one sensor 103 includes an image sensor (possibly comprised in a camera module). In one embodiment, the at least one sensor 103 includes an audio sensor for recording sounds, such as voice input. In one embodiment, the at least one sensor 103 includes a biometrics sensor for capturing biometric data such as for example retina scans, fingerprint scans or other biometric data. In one embodiment, the at least one sensor 103 includes a tactile sensor for capturing tactile or haptic input.

In some embodiments, the file management arrangement 100 also comprises a user interface 110, for receiving user input and for providing information to the user. In some embodiments, as is indicated in FIG. 1A using dashed lines, the file management arrangement 100 is operably connected to such a user interface 110.

In some embodiments the file management arrangement 100 also comprises a communications interface 104 for communicating with other file management arrangements 100, sensors 103 or servers (not shown). In some embodiments, as is indicated in FIG. 1A using dashed lines, the file management arrangement 100 is operably connected to such a communications interface 104.

In some embodiments, the communications interface 104 comprises a radio frequency (RF) communications interface. In one such embodiment, the communication interface 104 comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment, the communication interface 104 comprises a cellular communications interface such as a fifth generation (5G) cellular communication interface, an LTE (Long Term Evolution) interface, a GSM (Global System for Mobile Communications) interface and/or other interface commonly used for cellular communication. In some embodiments, the communications interface 104 is configured to communicate using the UPnP (Universal Plug n Play) protocol. In some embodiments, the communications interface 104 is configured to communicate using the DLNA (Digital Living Network Appliance) protocol.

In some embodiments, the communications interface 104 comprises a wired interface. In some such embodiments, the communication interface 104 comprises a USB (Universal Serial Bus) interface. In some alternative or additional such embodiments, the communication interface 104 comprises a HDMI (High Definition Multimedia Interface) interface, a Display Port interface, an Ethernet interface, a MIPI (Mobile Industry Processor Interface) interface, an analog interface, a CAN (Controller Area Network) bus interface, an I2C (Inter-Integrated Circuit) interface, or other interface.

FIG. 1B shows a schematic view of a file management arrangement 100 as in FIG. 1A according to some embodiments of the teachings herein. In the example embodiment shown in FIG. 1B, the file management arrangement 100 is a telecommunication User Equipment. In one such embodiment, the file management arrangement 100 is a smartphone. In one alternative such embodiment, the file management arrangement 100 is a tablet computer.

Furthermore, the file management arrangement 100 according to FIG. 1B comprises a user interface 110 comprising a display 110A and one or more buttons 110B. In embodiments where the display 110A is a touch display, the at least one, some or all of the one or more buttons 110B are virtual buttons implemented through the touch display 110A.

As discussed in relation to FIG. 1A, the one or more sensors 103 include an image sensor 103, possibly as part of a camera module, for receiving and capturing image data. The one or more sensors 103 also include (at least in some embodiments) a microphone for receiving and recording audio data (such as voice data). In embodiments where the sensor 103 comprises an image sensor, the file management arrangement 100 is also referred to as a file management arrangement 100.

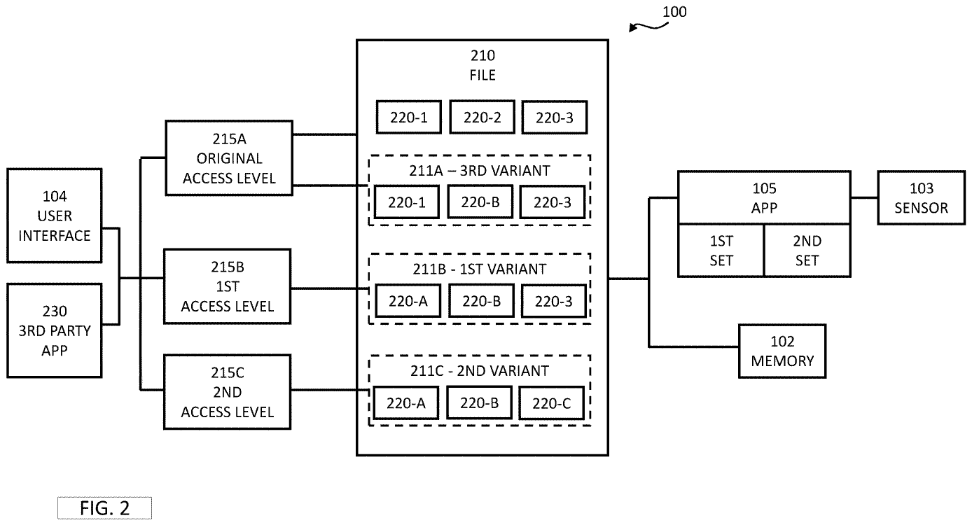

FIG. 2 shows a schematic view of a file management arrangement 100 and management of one or more files 210. The file 210 is associated with an application 105. In some embodiments, the file 210 is stored in a memory 102 and may be retrieved therefrom by the application 105.

The application 105 is in some embodiments the application generating the file 210. In some such embodiments, the application is arranged to receive sensor data from a sensor 103, such as the sensor 103 of the file management arrangement 100 and generate the file 210 based on the received sensor data. In some embodiments, and as discussed in the above with reference to FIGS. 1A and 1B, the sensor 103 may be or include an image sensor whereby the file generated is an image (or video) file 210.

The file 210 includes or comprises one or more objects 220-1, 220-2, 220-3. In embodiments where the file 210 is an image file 210, the objects 220-1, 220-2, 220-3 are image objects, for example faces, bodies, texts labels (names, license plates, signs and so on), cars or other commonly known image objects.

The file management arrangement 100 is configured to receive a request for the file 210. The request may be for a file 210 stored in the memory 102. The request may alternatively be for generating the file 210, such as a command to capture an image. The request is in some embodiments received from a user—for example of the application 105—through a user interface 104. The request is in some embodiments received from or via a third-party application 230. In this instance, a third-party application 230 is in some embodiments an application not related to the application 105, or alternatively, a third-party application 230 is in some embodiments an application being executed in a different arrangement or device and is thus a remotely executed application. In some embodiments the request is a composite request comprising a first request received from a user through a user interface 104, the first request being a user interface operated user request, and a second request received being a third-party application request.

For the context of this document a third-party application 230 will be considered as any application not part of the application 105. In some embodiments the third-party application 230 is executed on a separate device. In some embodiments the third-party application 230 is executed on the file management arrangement 100. In some such embodiments, the third-party application 230 is a built-in or pre-installed application on the file management arrangement 100, such as a default application.

The request is associated with an access level 215. As can be seen in FIG. 2, more than one access level is possible, wherein one access level—hereafter referred to as an original access level 215A—provides access to an original version of the file 210. Also, there are one or more other access levels—hereafter referred to as a first access level 215B and a second access level 215C—providing access to variants 211 of the original file 210.

As is illustrated in FIG. 2, the file 210 comprises the one or more original objects 220-1, 220-2, 220-3 and the variants 211 comprises one or more replacement objects 220-A, 220-B, 220-C for at least one of the original objects 220-1, 220-2, 220-3. In the example of FIG. 2, a first variant 215B comprises two replacement objects 220-A, 220-B and one original object 220-3, where the two replacement objects 220-A, 220-B replace the two original objects 220-1 and 220-2. A second variant 215BC comprises three replacement objects 220-A, 220-B, 220-C replacing the three original objects 220-1, 220-2 and 220-3. Each variant 211 thus has a number (one or more) of replacement objects that are used to replace corresponding original objects.

It should be noted that even though FIG. 2 shows a first access level 215B and a second access level 215C in addition to the original access level 215A, in some embodiments there may only exist a first access level 215B and in some embodiments several further access levels may exist which may be all referred to as second access levels 215C.

In some embodiments, the first and the second access levels relate to a hierarchical access system, wherein the first access level 215B relates to an access level further up in the hierarchical access system than the second access level 215C. In such embodiments, the number of replacement objects for the first variant 215B is less than the number of replacement objects for the second variant 215C. The second variant 211C (and thus the second access level 215C) is thus associated with a higher degree of anonymization than the first variant 211B (and thus the first access level 215B), wherein a higher degree of anonymization implies that more anonymization is to be performed. A level above another level in the hierarchical access system will thus have fewer anonymizations than the another level. In some such embodiments, the second variant 211C includes all replacement objects 220A, 220B of the first variant 211B.

In some embodiments the first and the second access levels relate to different anonymizations, wherein the first access level 215B is for a first type of anonymization and the second access level 215C is for a second type of anonymization. In some such embodiments the associated variants are different, whereby the replacement objects of the first variant 211B are different from the replacement objects of the second variant 211C and/or the first number for the first variant 211B is different from the second number of the second variant 211C.

Thus, in some embodiments, the controller 101 of the file management arrangement 100 is configured to receive a request for a file 210 and determine an access level 215 for the request. The controller 101 determines if the access level 215 corresponds to an original access level (215A) and if yes, provides the original file 210. Otherwise, if the controller determines that the access level (215) does not correspond to an original access level 215A, the controller provides a variant 211 of the file 210 corresponding to the access level 215. For example, if the access level is the first access level 215B, the controller provides a first variant 211B of the file 210 corresponding to the first access level 215B, wherein the first variant 211B of the file 210 includes the first number of one or more replacement objects 220-A, 220-B replacing the first number of the one or more original objects 220-1, 220-2. And, for example, if the access level is the second access level 215C, the controller provides the second variant 211C of the file 210 corresponding to the second access level 215C, wherein the first variant 211B of the file 210 includes the first number of one or more replacement objects 220-A, 220-B replacing the first number of the one or more original objects 220-1, 220-2.

As is also shown in FIG. 2, there is in some embodiments a third variant 211A of the file 210, wherein some anonymizations have been removed. This variant is associated with a third access level. This allows for having variants 211 of the file 210 that the user or application having the original access level prefers. For example, in a file management arrangement 100 where the application 105 generates a file and automatically provides an anonymized variant, the user (or application) may change or modify some of the replacement objects provided by the automatic anonymization, for example by replacing one replacement object by another. A face that has been blurred may be replaced by another face, for example by replacing it with a more pleasing image of the face or by reintroducing the original face. In FIG. 2, this is indicated by the third variant having maintained the original object 220-1 instead of the replacement object 220-A. The third variant is thus a user-adapted variant of the original file, where some anonymization has been removed by the user. As the third variant has fewer replacement objects it needs to be at a higher access level, which can be the original access level.

The controller 101 is thus also in some embodiments configured to provide a third variant 211A of the file 210 in response to determining that the access level 215 corresponds to the original access level 215A, wherein the third variant 211A includes a third number of replacement objects 220-A, 220-B, 220-C, wherein the third number is lower than or equal to the first number and/or the third number of replacement objects 220-B is different to the first number of replacement objects 220-A.

Such embodiments of a file management arrangement 100 as disclosed herein, both in the above and in the below enable classification of files, in particular media files, depending on whether objects have been anonymized (first and second variants 211B, 211C), and whether the recommended anonymization has been modified (third variant 211A). This classification can then be used to put restrictions on how such media files can be accessed and used by different apps and/or the user, and how the apps can share the media files.

In some embodiments, the file management arrangement 100 might thus support three different classifications: O (original—no anonymization), A (anonymized according to system recommendation first—and second variants 211B, 211C), and B (anonymization adapted by user—third variant 211A). For example, the user is assumed to have full privileges to manage anonymization, i.e., original access level privileges. If the user follows the system recommendation when taking a photo, in terms of which faces shall be anonymized, the resulting file will be classified as an A file, i.e., anonymized according to system recommendation and result in a first or second variant 211B, 211C. If the user anonymizes additional faces, this is still an A file, such as when altering a first variant 211B. However, if the user reduces the amount of anonymization for any of the faces (or other objects), or even removes all anonymizations, the file will be a B file (third variant 211A). It should be noted that the three classifications do not necessarily directly correspond to the three access levels discussed, and there may be several access levels, for example one access level that allows access to the first variant 211A, and another access level that allows access to the second variant 211B. The same classification can thus be associated with more than one access level.

In some embodiments, the file management arrangement 100 is configured to store some or all variants 211 of the file including the file 210. In some embodiments, the variants 211 are stored in the memory 102 whereby the variant is retrieved and provided when the request for the file is received. In some embodiments, these variants are generated as a request for the file 210 is received. In some embodiments, the controller is configured to determine that the request for the file is for a variant 211 stored in a memory 102 and in response thereto provide the variant 211 for the file 210 stored in the memory 102, and if not, generate the variant 211 of the file 210 in response to receiving the request and provide the generated variant 211.

In some embodiments, some or all of the variants 211 are stored as (full) copies of the original file with the relevant objects replaced. In such embodiments a variant is stored as a copy wherein the replacement objects are part of the variant. In the example of an image where a face is to be blurred, a full copy is a copy of the image but with the face blurred. In some embodiments, some or all of the variants 211 are stored as files with an indication of which original object 220-1, 220-2, 220-3 is to be replaced and by what replacement object 220-A, 220-B, 220-C. In such embodiments, the original object 220-1, 220-2, 220-3 to be replaced is replaced with the replacement object 220-A, 220-B, 220-C upon retrieving the variant 211.

In some embodiments, the original file 210 can be stored in the background in addition to the variant, but only saved for a limited time (temporal limitation) or e.g., saved if/as long as a device housing the file management arrangement 100 is within a limited geographical area. These are examples of temporal-spatial or spatial limitations for the storing of the original file 210.

In some embodiments, the original file is encrypted—possibly after a time limit has expired or a geographical area has been left. For example, when a user has taken photos that might be of interest to the police (criminal act), these photos may be encrypted and made inaccessible to the user instead or they may be deleted when moving out from the geographical area, still allowing for the police to retrieve the photos using the correct encryption key. The original files may thus not be accessed by the user unless the user has certain privileges. There may be situations, e.g., police matters, where the photo may contain important evidence and support for recreation of the original raw data (original file) may be required by regulation.

As mentioned above, the request for the file may be to generate the file, such as for capturing an image. In some embodiments, the controller 101 is thus configured to receive sensor data from a sensor 103 and to generate the variant 211 corresponding to the access level 215 based on the received sensor data. This allows or the variant 211 to be automatically generated when the file is generated.

In some embodiments, the file management arrangement 100 may be based on user settings enabling the user to grant different access to different applications 105,250. For example, when the user enables access to photos to an application 105, 250, the user can determine whether that application 105, 250 shall be granted only A files or both A and B files. There may be restrictions so that certain apps cannot be granted access to B files because of e.g., a risk of spreading privacy-intruding files to e.g., social media platforms. Even if the user can view B files (or even O files) and let certain apps have access to B files, certain embodiments may implement restrictions preventing B files to be sent as attachments to emails or to be included in messages since that may otherwise be a way to circumvent privacy limitations.

In FIG. 2 it is indicated that an application 105 may be associated with a set of functions (1ST SET and 2ND SET) and that the set of functions allowed to be used are based on the access level granted by (or to) the user (or other application).

In some embodiments, the different sets of functions relate to different file generation functions (image manipulation functions for example) and the image file may thus be generated differently depending on which access level is currently being used. In some embodiments, the controller 101 is thus further configured to generate the file as a capture of the sensor data and receive the sensor data through a file generating application 105, and wherein the file generating application 105 comprises a first set of functionalities associated with the original access level 215A and a second set of functionalities associated with the first access level 215B.

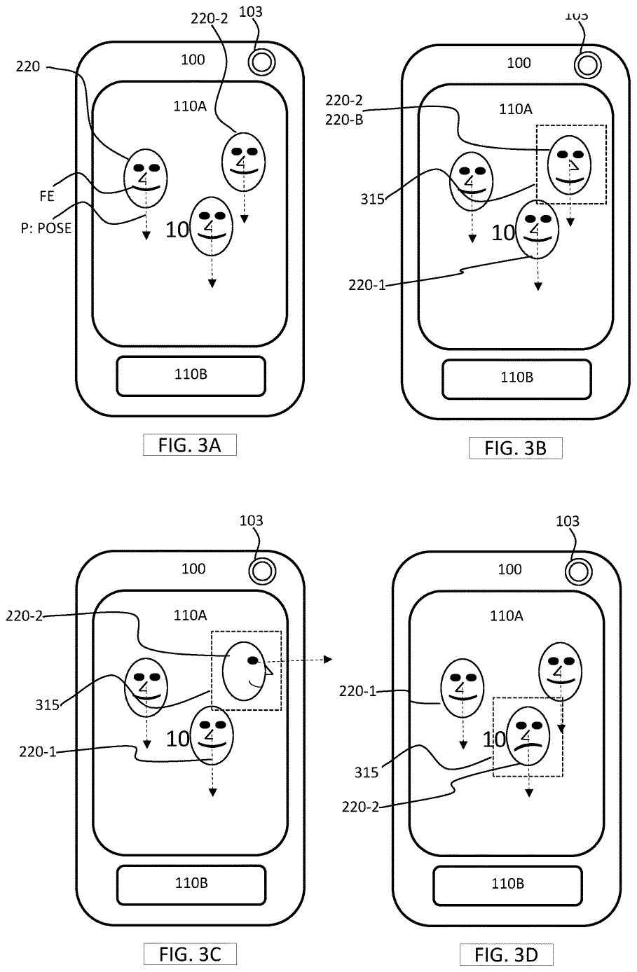

As mentioned in the above, the file 210 may be anonymized automatically. The file may be anonymized as it is received from another device, as it is retrieved from the memory or as it is generated. In the following, different examples and embodiments of how a file may be anonymized will be discussed with reference to FIGS. 3A to 3K.

FIG. 3A shows a schematic view of an example of a file management arrangement 100 of FIG. 1B, such as a smartphone, where an image 300 received from a camera 103 is displayed on the display 110A. It should be noted that the image 300 corresponds to the file 210, for example in such a manner that the image 300 is the result of processing the file 210.

In this example, the image 300 comprises three objects 220, which in the example of FIG. 3A are three persons, represented by the three faces being displayed on the display 110A. Each person 220 exhibits one or more visible traits, for example a pose P and/or a posture, such as a body posture, a gesture or a facial expression (FE). In the example of FIG. 3A, these traits are exemplified as a pose P and a facial expression FE. The pose P, which includes a position and a general direction of interest, is indicated by an arrow indicating a line of sight for the faces. A facial expression FE is also shown for each face 220. The pose P may be determined based on the direction of the line of sight, eye the direction of the eyes. The pose may alternatively or additionally be determined based on (the direction of) the nose is pointing in or other facial features. A facial expression may be determined through smile detection. A body posture may be detected signaling an emotion. For example, a closed fist would signal anger.

It should be noted that these visible traits are examples of the context for the objects 220, individually or in combination. Other examples of such a context is the identity of a person, the geographic location of the image, the time of the image 300, to mention a few.

As discussed in the above, the file management arrangement 100 is configured to detect such objects 220 in the image 300. The file management arrangement 100 is specifically configured to detect at least one object to be replaced 220-2 based on the contextual information.

FIG. 3B shows an example where an object to be replaced 220-2 has been detected. In this example the object 220-2 is a person represented by a face. The object may also be only a face. In this example, the object to be replaced has been detected based on the contextual information of the identity of the object 220-2. In the example of FIG. 3B, the object to be replaced 220-2 has already been replaced by a replacement object 220-B as indicated by the nose of the face of object 220-B being different to that of object 220-2.

In some embodiments, an object may be detected to be an object to be replaced based on an identity of the object, wherein the identity is a blocked identity. Examples of such blocked identities are identities that have been blocked in a contact application or in a social media application.

In some embodiments, an object may be detected as an an object to be replaced based on the identity of the object, wherein the identity is an identity that is not associated with identities of other objects 220-2 in the image 300. One example of such identities is when the person to be replaced 220-2 is not associated (friends) with the other persons 220-1 in the image, for example based on a social media app. Another example of such identities is where the identity of the person to be replaced 220-2 is not present in a contact list stored in the memory 102 of the smartphone 100.

The file management arrangement 100 is thus also, in some embodiments, configured to determine an identity associated with the detected object. In some embodiments, the identity may be determined based on facial recognition.

In some embodiments, the image capturing device is further configured to indicate which object 220-1 that is detected is to be replaced, for example, through a graphic indication. In the example of FIG. 3B, the person to be replaced 220-2 is indicated by a graphical object (in this example a frame) 315 being displayed around or on top of the person to be replaced 220-2. This allows for a user to quickly see and ascertain which person is to be replaced.

In some embodiments, also other detected objects are indicated by a graphical indication to indicate to a user that these objects have been detected but are not proposed to be replaced. In some such embodiments, the graphical indication for indicating an object to be replaced is displayed differently (for example in one color) from the graphical indication for the objects detected, but not proposed to be replaced (for example in a different color).

In some embodiments, also undetected objects may be graphically indicated to a user that they have not been successfully detected or categorized and are unknown. In some such embodiments, the graphical indication of an unknown object is displayed differently (for example in one color) from the graphical indication for objects that have been detected. In some embodiments, unknown objects are automatically determined to be objects to be replaced 220-2. In some embodiments, unknown objects are automatically determined to be other objects 220-2 (i.e. to base the context upon). In some embodiments, this automatic determination is based on user settings.

In some embodiments, the determination or a change of an automatic determination may be changed by a user and in such embodiments, the file management arrangement 100 is further configured to receive user input indicating such an object.

FIG. 3C shows an example where a person (being an example of an object) to be replaced 220-2 has been detected. In this example the person to be replaced has been detected based on the contextual information that the pose of the person to be replaced is different from the other persons 220-1 in the preview. As can be seen, the person to be replaced 220-2 is looking to the side, while the other persons 220-1 are looking straight into the camera (indicated by the arrows pointing downwards). In one such embodiment, the file management arrangement 100 is configured to determine a pose of each detected object, to determine if the majority (two or more) of the objects have a similar pose and if at least one object has a different pose, and if that is the case, detect the object(s) with the different pose as the object to be replaced 220-2.

The file management arrangement 100 is thus also, in some embodiments, configured to determine a pose associated with an object.

FIG. 3D shows an example where a person (being an example of an object) to be replaced 220-2 has been detected. In this example, the person to be replaced has been detected based on the contextual information that the posture of the person to be replaced is different from the other persons 220-1 in the preview. The posture of a person is in some embodiments a body posture, a gesture and/or a facial expression.

In the example of FIG. 3D, the person to be replaced 220-2 is presenting an unhappy facial expression in the form of a shape of the mouth being essentially concave upward, while the other persons 220-1 are presenting happy facial expressions (they are smiling) in the form of the shape of the mouth being essentially concave downward. In some embodiments, the circuitry for object detection is thus further configured to perform facial recognition to determine facial expressions.

In another example (not shown), the person to be replaced is presenting a gesture. In some embodiments, the object presenting a rude or otherwise unallowed gesture is detected to be replaced. In such embodiments, the file management arrangement 100 is further configured to detect gestures, possibly based on image analysis by comparing them to an image library of known gestures, wherein some gestures are indicated to be unallowed.

In some embodiments, the image library is stored locally in the memory 102. In some embodiments the image library is stored on a portion of the memory being dedicated to or even comprised in the circuitry for object detection. Furthermore, in some embodiments the image library is stored remotely, for example on a server, and accessed through the communication interface 104.

In some embodiments the file management arrangement 100 is further configured to determine that the other persons 220-1 are not making similar gestures and if that is the case, detect the person making the gesture as the person to be replaced 220-2. This allows for a group photo where the whole group presents rude gestures to be unaltered, while situations where only a by-passer is presenting the gesture is altered.

In another example (not shown), the person to be replaced 220-2 is exhibiting a body posture (for example standing), while the other persons 220-1 are exhibiting a different body posture (for example laying down). In some embodiments, the circuitry for object detection is thus further configured to perform body posture detection.

In one such embodiment, the file management arrangement 100 is configured to determine a posture of each detected object, to determine if the other objects 220-2 have a similar posture and if at least one object has a different posture, and if yes, detect the object(s) with the different posture as the object to be replaced 220-2.

FIG. 3E shows an example where a person (being an example of an object) to be replaced 220-2 has been detected. In this example, the person to be replaced has been detected based on the contextual information that the geographic location of the person to be replaced is different from the other persons 220-1 in the preview. That the geographic location of the person to be replaced is different from the others may in some embodiments be determined based on a difference in distance between objects/persons.

In the example embodiment shown in FIG. 3E the person to be replaced 220-2 is at a distance d1 from the other persons 220-1, while the other persons 220-1 are at a distance d2 from one another. The distance d2 can be measured in a number of manners and may depend on how the person is shown. In some embodiments, the distance d2 is measured from person to person such as the smallest distance between the face or body of the persons (depending on what is displayed). In some embodiments the distance d2 is measured from a common center point, such as the chest for full-bodied representations or for example, the noses for face representations.

In some embodiments, the distance d2 between the other persons 220-1 is determined based on an average of the distances between the other persons 220-1. And, in some embodiments the distance d2 between the other persons 220-1 is determined based on a median of the distances between the other persons 220-1.

In some embodiments, it is determined that the person to be replaced 220-2 is at a different geographic location if the distance d1 exceeds a threshold distance. In some embodiments the threshold distance is based on the distance d2 between the other persons, wherein the threshold distance is a factor (for example 1.5, 2, 3, 4, 5) of the distance d2 between the other persons 220-1.

In some embodiments, the circuitry for object detection is further configured to determine geographic locations of objects. The geographic location may be determined by detecting objects corresponding to landmarks and identifying these landmarks. The geographic location may be determined by retrieving a location from a location sensor such as a GPS (Global Positioning System) device.

FIG. 3F shows an example where a person (being an example of an object) to be replaced 220-2 has been detected. In this example, the person to be replaced has been detected based on the contextual information that the movement (speed and/or direction) of the person to be replaced is different from movement of the other persons 220-1 in the preview which is indicated by the velocity vector v1. In the example of FIG. 3F, the person to be replaced is moving fast to the left of the image, whereas the other persons 220-1 are moving slowly to the right illustrated by the velocity vectors v2. The movements are thus different.

In some embodiments, the file management arrangement 100 is further configured to determine movements of objects, such as by tracking an object and determining a difference in location in the image at different (subsequent) times.

The other persons 220-1 are in some embodiments defined as the majority of detected persons. The other persons 220-1 are in some embodiments defined as detected persons having associated identities. The other persons 220-1 are in some embodiments defined as persons exhibiting similar poses, or postures. The other persons 220-1 are in some embodiments defined as persons being at a location close to one another, for example less than 1.5 times the distance d2. The other persons 220-1 are in some embodiments defined as persons exhibiting a similar movement.

In some embodiments, and as discussed in the above, the contextual information may be the geographic location of the sensor 103. In such embodiments the file management arrangement 100 is further configured to determine that if the geographic location for the sensor (i.e. where the image 300 is received) is a specific geographic location, then specific determinations for the context is to be applied. For example, if the geographic location is a geographic location marked as sensitive, all persons with clearly recognizable faces are to be replaced.

In some embodiments, and as also discussed in the above, the contextual information lmay be the time stamp of the file (i.e. the time at which the file was created). In such embodiments, the file management arrangement 100 is further configured to determine that if the time stamp is a specific time, then specific determinations should be applied.

Specifically, the context of a geographic location and a time, may infer specific contextual determinations such as that any file or sensor data received at a specific geographic location at a specific time is subjected to specific contextual determinations. One example of a contextual determination may be that it is forbidden to take photos of license plates of cars at night, whereby all license plates are removed or blurred in images taken during night hours in such streets. Another example is where it is not allowed to take photos identifying children at schools during school hours, whereby all faces are blurred or replaced by anonymous faces from images taken during such hours.

It should be noted that the embodiments and examples discussed in the above may be combined in any manner where any, some or all of the contexts discussed are combined for one or more objects in the file or sensor data. For example, there may be a person that has a blocked identity that is performing a rude gesture, while at the same time, there may be a person moving away from the group and exhibiting a different pose in the same file or sensor data, wherein both such persons will be detected as being persons to be replaced.

As alternative examples of identities to persons with identities, it should be mentioned that objects with identities may be logos and/or textual identities. A logo, such as a trademark, may easily be detected and identified by the circuitry for object detection. Similarly, any textual information, such as a name, may also be easily detected and identified. A logo or textual information may also easily be replaced.

It should be noted that even though most examples given herein are related to images and detecting objects in such images giving some examples of contexts, other contexts may also be used to determine if an object is to be replaced or not.

In some embodiments, the file management arrangement 100 may also learn and use information such as geographic location, social circles etc. to adapt the contextual determinations that determine which objects to be replaced.

Returning to FIG. 3B, in the example shown in FIG. 3B (and also in FIGS. 3C-3F) graphical indication is used in some embodiments to indicate or mark the object 220-2 to be replaced. FIG. 3G shows an example situation where an object, in this example a person represented by a face, is marked as being an object to be replaced 220-2. The marking is achieved by displaying a graphical indication 315 marking the object 220-1. In this example the graphical indication 315 is a frame encompassing the face 220-1. In some embodiments, the graphical indication 315 is in a color that contrasts with the background. In some embodiments, the graphical indication 315 is in a color that indicates the context of the object, indicating to a user why the object is to be replaced. For example, a first color (red) can be used to indicate a first context (for example a blocked identity) and a second color (yellow) can be used to indicate a second context (for example an unknown identity). This enables a user to understand why an object is proposed to be replaced.

In some embodiments, the image capture arrangement 100 is further configured to receive user input through the user interface 110 indicating an acceptance of an object to be replaced. In some such embodiments, utilizing a touch display 110, the input may be received as a double tap on the object 220-1 or anywhere else inside the marking 315. Alternatively, in some such embodiments having physical keys 110B, the input may be received as a press on a softkey or other key indicating acceptance. As a skilled person may realize, a softkey is a key whose function differ depending on the current execution state and whose function may be indicated by being displayed on the display 110A.

In some embodiments, the image capture arrangement 100 is further configured to receive user input through the user interface 110 indicating a detected object 220-1 to be an object to be replaced. In some such embodiments, utilizing a touch sensitive display 110, the input may be received as a long press or double tap on the object 220-2 or anywhere else inside its marking (if a marking is displayed).

In some embodiments, the image capture arrangement 100 is further configured to receive user input through the user interface 110 indicating an undetected object to be an object to be replaced or to be an object to be kept (i.e., another object). In some such embodiments utilizing a touch display 110, the input may be received as a double tap or a long press on the object 220 or anywhere else inside its marking (if a marking is displayed).

In some embodiments all proposals are accepted by receiving a command to execute the capture, i.e., to take the picture.

In some embodiments, the graphical marking 315 is displayed differently in response to receiving an acceptance. As an example, a graphical frame 315 being displayed as dashed lines for a proposed object may be changed to a solid line for an accepted object. Alternatively, the color of the marking may be changed as the object is accepted.

Similarly, in some embodiments, the image capture arrangement 100 is further configured to receive user input through the user interface 110 indicating a rejection or cancellation of an object to be replaced. In some such embodiments utilizing a touch sensitive display 110, the input may be received as a long tap on the object 220-1 or anywhere else inside the marking 315. Alternatively, in some such embodiments utilizing physical keys 110A, the input may be received as a press on a cancellation or clear key. Alternatively, the input may be received as a press on a softkey 110A being indicated to be for cancellation.

In some embodiments, the graphical marking 315 is no longer displayed or removed in response to receiving a cancellation.

As discussed in the above, the object to be replaced 220-2 is to be replaced by a replacement object (referenced 220-B in FIG. 3H), and in some embodiments, the object to be replaced 220-2 or rather a proposed object to be replaced 220-2 is replaced already in the preview to indicate to the user what the final image will look like. Alternatively, the proposed object to be replaced 220-2 may be replaced first upon receiving an acceptance of the replacement object 220-B.

In some embodiments, the image capture arrangement 100 is further configured to receive user input through the user interface 110 requesting a (next or further) proposed replacement object (referenced 220-B in FIG. 3H) to be displayed.

In some such embodiments utilizing a touch display 110, the input may be received as a single tap on the object 220-1 or anywhere else inside the marking 315, whereby a (next) proposed replacement object (referenced 220-B in FIG. 3H) is displayed for later acceptance. Alternatively, in some such embodiments utilizing physical keys 110A, the input may be received as a press on a navigation (arrow) key. Alternatively, the input may be received as a press on a softkey 110A being indicated to be for proposing a next replacement object (referenced 220-B in FIG. 3H).

In response to receiving such input, a replacement object (referenced 220-B in FIG. 3H) is displayed instead of the original object, in case the original object is displayed, and a further or second replacement object (referenced 220-B in FIG. 3H) is displayed instead of the first replacement object (referenced 220-B in FIG. 3H).

FIG. 3H shows an example of a replacement object 220-B to be used instead of the object to be replaced 220-2. In the example of FIG. 3H an alternative or modified object, in this example, a modified face 220-B, is shown. This is indicated by the replacement face 220-B being (slightly) different from the original face 220-1 of FIG. 3G. In FIG. 3H this is indicated by the face having a different nose which indicates a different pose.

In some embodiments, the replacement face is an autogenerated face that in some embodiments is generated utilizing a generative adversarial network, GAN for example using StyleGAN. In some embodiments, the replacement face is a replacement face retrieved from an image library stored either locally or remotely.

This also applies to persons (full or partial bodies), where the replacement person is an autogenerated image of a person or retrieved from an image library.

FIG. 3I shows an example of an alternative where the replacement object—in this example the face—is a blurred object—in this case a blurring of the face.

FIG. 3J shows an example of an alternative where the replacement object—in this example the face—is a deleted version of the object—in this case a deleted of blocked face. The deletion may be achieved by overlaying the face with a different object, such as an estimation or generation of a continuation of the background. The deletion may alternatively be achieved by overlaying the face (the object) with an empty space.

FIG. 3K shows an example of an alternative where the replacement object—in this example the face—is an alternative object. The alternative object is in some embodiments selected from an image library to be an object common to the context of the photograph. In some embodiments, the context of the photo may be based on the geographic location such as being in a forest wherein an object commonly found in a forest is inserted to replace the face, in the example of FIG. 3K, the replacement object is a plant. In some embodiments, the context of the photo may be based on an analysis of the background of the image wherein an object similar to other objects in the background of the objects is selected from an image library. Alternatively, a copy of an object present in the image may be used as the replacement object, whereby a copy of for example a plant may be used instead of the face to be replaced.

In the examples of FIGS. 3H to 3K a user may be able to scroll through the different alternatives of these figures by providing the user input for displaying a next proposal, effectively scrolling through the examples of FIGS. 3H to 3K.

In alternative embodiments, the marking may display numbers, letters or any character, where the character is associated with a command (scroll, accept, decline, change) and the user inputs the command by simply pressing the key for the corresponding character.

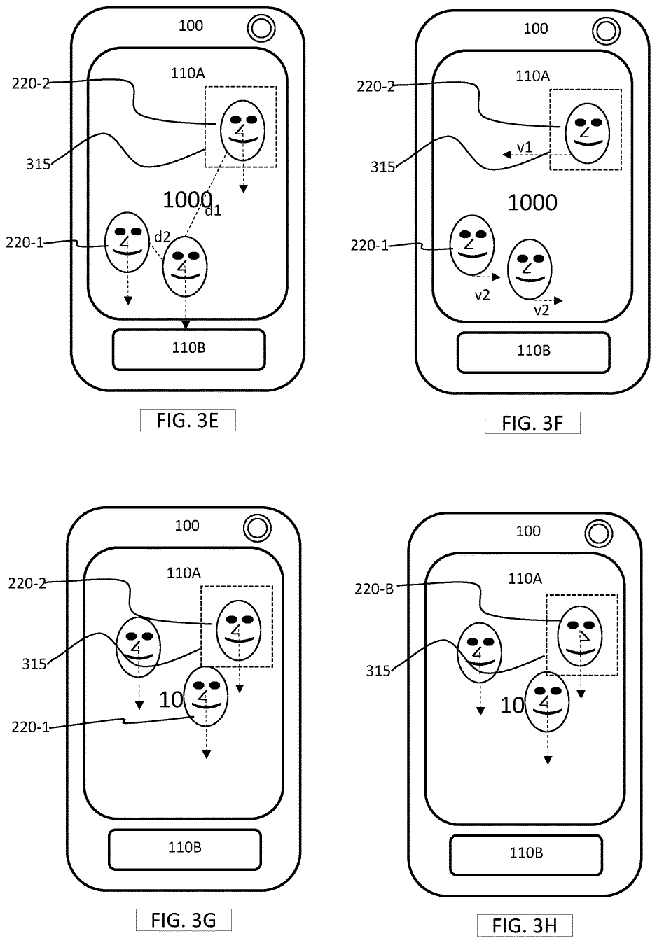

FIG. 4 shows a schematic view of how a file 210 may be anonymized on several occasions and by different file management arrangement 100s. FIG. 4 shows a first file management arrangement 100-1 which is being used by a user (through an application 105) having a first access level 215B. An image—corresponding to the file 210—is shown on the display 110. In this example the image has already been anonymized according to the access level of the user and a first variant including a replacement object 220-A is displayed.

A request for the file is retrieved from a second file management arrangement 100-2. The request can be received through a local application 105 to forward a file 210 or from a third-party application 250 for retrieving the file 210. In either case, the request is associated with a second access level 215C, and the file 210 is further anonymized. In some embodiments, the further anonymization is provided already by the first file management arrangement 100-1 upon transmitting the file or the variant thereof. In some embodiments the further anonymization is provided by the second file management arrangement 100-2 upon receiving the file or the variant thereof. As is shown, a second variant of the file 210 is displayed on the second file management arrangement 100-2 where the second variant includes a replacement object 220-B.

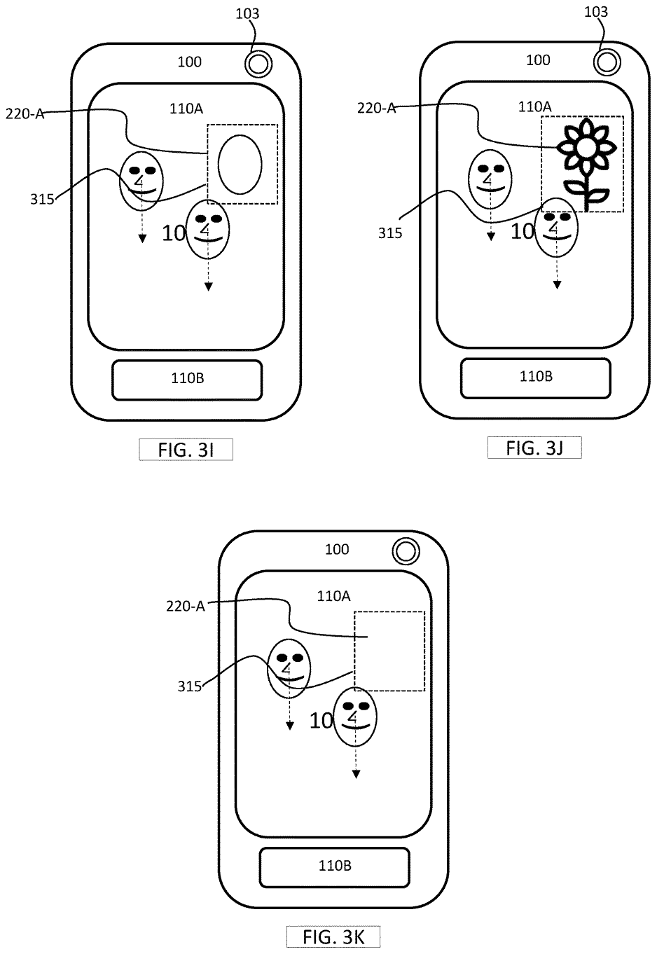

FIG. 5 shows a flowchart for a general method according to the teachings herein. The method is to be executed on a file management arrangement as discussed in FIG. 1A or in FIG. 1B in a manner as discussed in relation to FIG. 2, any, some or all of FIGS. 3A to 3K, and FIG. 4.

The method comprises receiving 510 a request for a file 210 and determining 520 an access level 215 for the request. The method further comprises determining that the access level 215 corresponds to an original access level 215A and then providing 530 the file 210. The method also comprises determining 535 that the access level 215 does not correspond to an original access level 215A and providing 545 a first variant 211B of the file 210 corresponding to a first access level 215B, wherein the first variant 211B of the file 210 includes a first number of one or more replacement objects 220-A, 220-B, 220-C replacing the first number of the one or more original objects 220-1, 220-2, 220-3. As is discussed in the above, the access level may also indicate that a second variant should be provided having a second number of replacement objects.

The method may also comprise any, some or all of the embodiments discussed herein, specifically with regards to FIG. 2, any of FIGS. 3A to 3K, and FIG. 4.

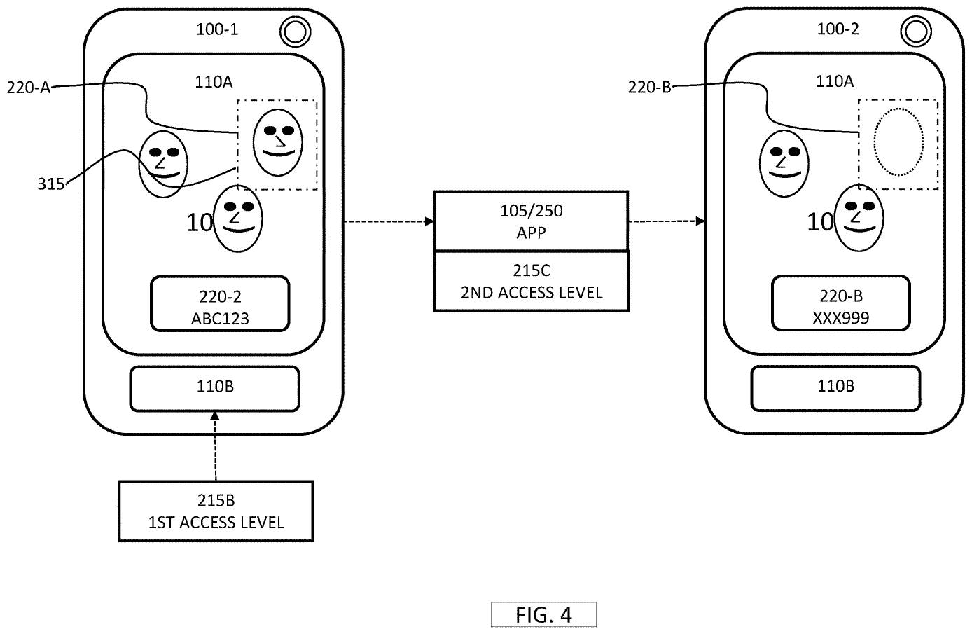

FIG. 6 shows a schematic view of a computer-readable medium 600 carrying computer instructions 610 that when loaded into and executed by a controller of a file management arrangement 100 enables the file management arrangement 100 to implement the present invention.

The computer-readable medium 600 may be tangible such as a hard drive or a flash memory, for example a USB memory stick or a cloud server. Alternatively, the computer-readable medium 600 may be intangible such as a signal carrying the computer instructions enabling the computer instructions to be downloaded through a network connection, such as an internet connection.

In the example of FIG. 6, a computer-readable medium 600 is shown as being a computer disc 600 carrying computer-readable computer instructions 610, being inserted in a computer disc reader 620. The computer disc reader 620 may be part of a cloud server 630—or other server—or the computer disc reader may be connected to a cloud server 630—or other server. The cloud server 630 may be part of the internet or at least connected to the internet. The cloud server 630 may alternatively be connected through a proprietary or dedicated connection. In one example embodiment, the computer instructions are stored at a remote server 630 and be downloaded to the memory 102 of the file management arrangement 100 for being executed by the controller 101.

The computer disc reader 620 may also or alternatively be connected to (or possibly inserted into) a file management arrangement 100 for transferring the computer-readable computer instructions 610 to a controller of the file management arrangement (presumably via a memory of the file management arrangement 100).

FIG. 6 shows both the situation when a file management arrangement 100 receives the computer-readable computer instructions 610 via a server connection and the situation when another file management arrangement 100 receives the computer-readable computer instructions 610 through a wired interface. This enables for computer-readable computer instructions 610 being downloaded into a file management arrangement 100 thereby enabling the file management arrangement 100 to operate according to and implement the teachings as disclosed herein.

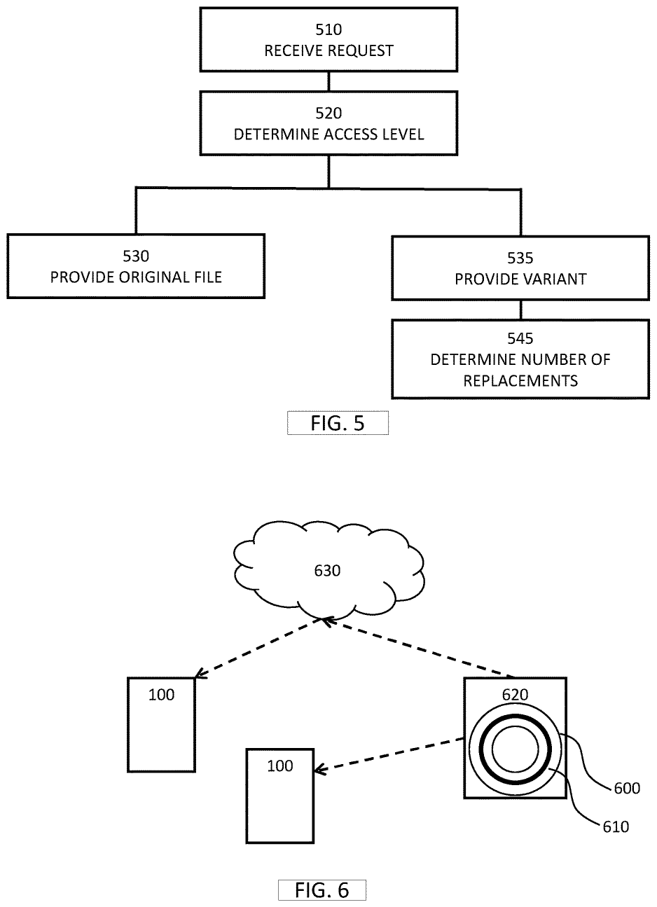

FIG. 7 shows a schematic view of a software component arrangement 700 for use in a file management arrangement 100 as discussed herein. The software component arrangement 700 comprises software code 710 for receiving a request for a file 210 and determining 720 an access level 215 for the request. The software component arrangement 700 also comprises software code 735 for determining that the access level 215 corresponds to an original access level 215A and then providing 630 the file 210. The software component arrangement 700 also comprises software code 735 for determining that the access level 215 does not correspond to an original access level 215A and providing 745 a first variant 211B of the file 210 corresponding to a first access level 215B, wherein the first variant 211B of the file 210 includes a first number of one or more replacement objects 220-A, 220-B, 220-C replacing the first number of the one or more original objects 220-1, 220-2, 220-3. As is discussed in the above, the access level may also indicate that a second variant should be provided having a second number of replacement objects.

The software component arrangement 700 also comprises software code 750 for further functionality as discussed herein, specifically as discussed herein with reference to FIG. 2d FIGS. 3A to 3K and FIG. 4.

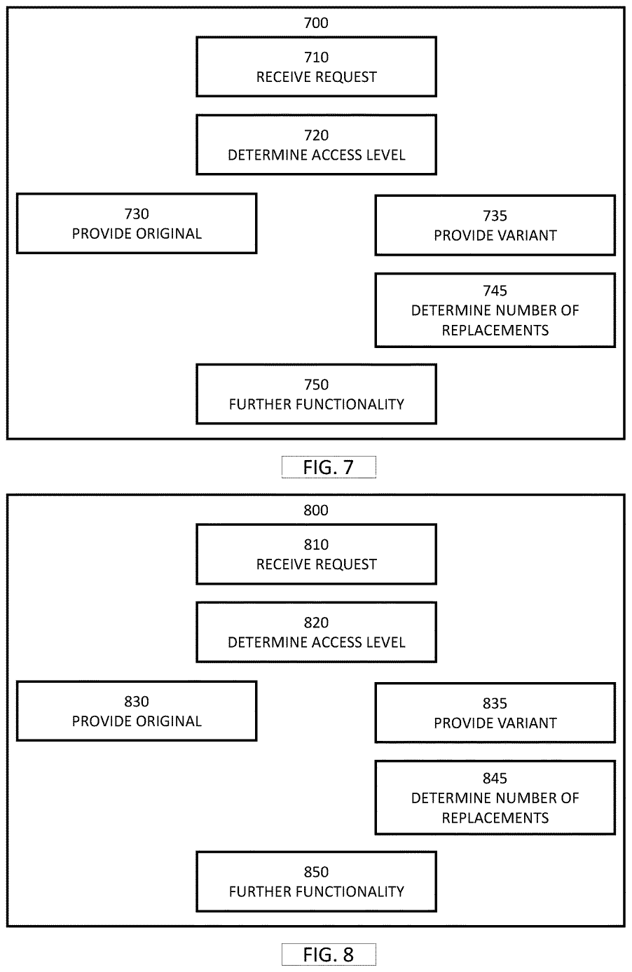

FIG. 8 shows a schematic view of a file management arrangement 800, such as the file management arrangement of FIG. 1A or FIG. 1B as discussed herein. The file management arrangement 800 comprises circuitry 810 for receiving a request for a file 210 and determining 820 an access level 215 for the request. The file management arrangement 800 also comprises circuitry 835 for determining that the access level 215 corresponds to an original access level 215A and then providing 630 the file 210. The file management arrangement 800 also comprises circuitry 835 for determining that the access level 215 does not correspond to an original access level 215A and providing 845 a first variant 211B of the file 210 corresponding to a first access level 215B, wherein the first variant 211B of the file 210 includes a first number of one or more replacement objects 220-A, 220-B, 220-C replacing the first number of the one or more original objects 220-1, 220-2, 220-3. As is discussed in the above, the access level may also indicate that a second variant should be provided having a second number of replacement objects.

The file management arrangement 800 also comprises circuitry 850 for further functionality as discussed herein, specifically as discussed herein with reference to FIG. 2, FIGS. 3A to 3K, and FIG. 4.

1-31. (canceled)

32. A file management arrangement comprising:
a memory; and
a controller configured to:
receive a request for an original file that comprises one or more original objects and is associated with a first application; and
provide a first variant of the original file corresponding to a first access level, responsive to an access level of the request corresponding to the first access level, wherein the first variant of the original file includes a first number of one or more replacement objects, each replacement object replacing a corresponding one of the one or more original objects,
wherein the controller is further configured to store in the memory any variant of the original file as an indication of which original objects are to be replaced, whereby each original object indicated for replacement is replaced upon retrieving the variant.

33. The file management arrangement according to claim 32, wherein the controller is further configured to:
provide a second variant of the original file corresponding to a second access level, responsive to the access level for the request corresponding to a second access level and wherein the second variant of the original file includes a second number of replacement objects replacing corresponding ones among the one or more original objects, wherein the first number is different than the second number, and/or wherein one or more replacement objects in the second number of replacement objects differ from one or more replacement objects in the first number of replacement objects.

34. The file management arrangement according to claim 33, wherein the first access level is a higher access level than the second access level and the first number is lower than the second number and wherein the second number of replacement objects includes the first number of replacement objects.

35. The file management arrangement according to claim 32, wherein the controller is further configured to provide a third variant of the original file responsive to the access level for the request corresponding to the original access level, wherein the third variant includes a third number of replacement objects, wherein the third number is lower than or equal to the first number of replacement objects.

36. The file management arrangement according to claim 32, wherein the request is a third-party application request and wherein the access level is a third-party application access level, wherein the third-party application is not the first application.

37. The file management arrangement according to claim 32, wherein the request is a user request received from a user through a user interface associated with the first application and wherein the access level is an access level for the user.

38. The file management arrangement according to claim 32, wherein the request is a composite request comprising a first request received from a user through a user interface, the first request being a user interface operated user request, and a second request received being a third-party application request.

39. The file management arrangement according to claim 32, wherein the controller is further configured to provide the first variant from a memory, in response to determining that the first variant is stored in the memory, or generate the first variant, in response to determining that the first variant is not stored in the memory.

40. The file management arrangement according to claim 32, wherein the controller is further configured to
determine that the request for the original file is for a file to be generated, and in response thereto generate the variant corresponding to the access level for the original file.

41. The file management arrangement according to claim 40, wherein the controller is further configured to receive sensor data from an image sensor and to generate the variant corresponding to the access level based on the received sensor data.

42. The file management arrangement according to claim 41, wherein the controller is further configured to
generate the original file as a capture of the image sensor data and
receive the sensor data through a file generating application, and wherein the file generating application comprises a first set of functionalities associated with the original access level and a second set of functionalities associated with the first access level.

43. The file management arrangement according to claim 32, wherein one of the replacement objects is a blurred version of the corresponding original object.

44. The file management arrangement according to claim 32, wherein one of the replacement objects is a substitute for the corresponding original object.

45. The file management arrangement according to claim 32, wherein the controller is further configured to detect each original object to be replaced based on a context of the original object.

46. The file management arrangement according to claim 45, wherein the context includes a geographical location where the file is to be generated and wherein the controller is further configured to determine that the geographical location is a geographical location indicated as sensitive, and to detect objects to be replaced as objects comprising an identity.

47. The file management arrangement according to claim 46, wherein the context further includes time of file generation, and wherein the controller is further configured to determine that the time of file generation is a time indicated as sensitive for the location of file generation.

48. The file management arrangement according to claim 45, wherein the controller is further configured to
detect at least one other object,
determine a context of the at least one other object,
compare the context of the original object to be replaced to the context of the at least one other object and to detect the original object to be replaced in response to the context of the original object being different from the context of the at least one other object.

49. The file management arrangement according to claim 45, wherein the context includes a pose, and wherein the original object is to be replaced in response to the pose of the original object being different from a pose of the at least one other objects object.

50. The file management arrangement according to claim 45, wherein the context includes a facial expression, and wherein the original object is to be replaced in response to the facial expression of the original object being different from a facial expression of the at least one other objects object.

51. The file management arrangement according to claim 45, wherein the context includes a distance to the at least one other objects, and wherein the original object is to be replaced in response to the distance to the at least one other object exceeding a threshold distance.

52. (canceled)

53. (canceled)

54. The file management arrangement according to claim 32, wherein the controller is configured to provide the original file in response to receiving a request having an access level corresponding to an original access level associated with the original file.

55. A method for use in a file management arrangement, wherein the method comprises:
receiving a request for an original file, the original file comprising one or more original objects, wherein the original file is associated with a first application;
providing a first variant of the original file corresponding to a first access level, responsive to an access level of the request corresponding to a first access level, wherein the first variant of the original file includes a first number of one or more replacement objects, each replacement object replacing a corresponding one among the one or more original objects; and
storing in the memory any variant of the original file as an indication of which original objects are to be replaced, whereby each original object indicated for replacement is replaced upon retrieving the variant.

56. A method of file management comprising:
receiving a request for an original file that contains one or more original objects and is associated with an original access level;
providing a variant of the original file in response to determining that an access level for the request is lower than the original access level, wherein modifications made with respect to the one or more original objects to obtain the variant depend on the access level for the request.
